(19) United States
(12) Patent Application Publication
(10) Pub. No.: US 2007/0212023 A1
(43) Pub. Date: Sep. 13, 2007

(54) Video filtering system

(75) Inventor: Rand P. Whillock, North Oaks, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/301,620

(22) Filed: Dec. 13, 2005

(51) Int. Cl. H04N 5/91

(52) U.S. Cl. 386/94

(57) ABSTRACT

A method, system, and computer program product is disclosed for selective filtering of video and audio content. Incoming content (e.g., video content and/or audio content) is broken into segments that are individually, on a segment-by-segment basis, analyzed using user-defined criteria, referred to as “cues”. Based on the quantity and weight of the cues in the segment, the segment is rated, i.e., given a score. If the score of a particular segment is above a predetermined threshold, the segment is stored for later use. If the segment is at or below the predetermined threshold, the segment is considered irrelevant or “uninteresting” relative to the user criteria, and the segment is discarded. Incoming content is buffered and, in parallel, a cue analysis is performed to break the content into segments and perform the rating process. In this manner, the streaming incoming content can be constantly monitored and analyzed and only the relevant/interesting segments are saved.

### STATEMENT OF GOVERNMENTAL INTEREST

This invention was made with U.S. Government support under Contract No. F10625 (Classified) under the VIEWS Program. The U.S. Government has certain rights in the invention.

### FIELD OF THE INVENTION

This invention relates to selective filtering of content streams and, more particularly to filtering video and/or audio streams to remove all but segments of interest.

### BACKGROUND OF THE INVENTION

Systems are known that perform news monitoring and video cataloging of the news being monitored. These systems automatically and in real time digitize, categorize, and store large volumes of streaming content. The incoming content is automatically segmented by identifying content clip boundaries and identifying the clip segments as stories or commercials. Scene change detection is used to identify the clip boundaries. Various audio and video analysis schemes are employed on the segments to detect/recognize words (both audio and on-screen video), voices (speaker identification), images (face recognition), etc. and then indexing techniques are employed to correlate the detected/recognized information with the particular location(s) in the content segment at which they occur.

Once the segments are indexed, they are categorized by saving them in folders, by subject. Every word gets categorized, every piece of video is categorized, and nothing is thrown out. This indexed library of content can then be searched using word-search techniques to allow a user to quickly and easily locate content of interest.

While the above-described systems give a user the ability to locate content segments containing desired content, it also requires massive amounts of storage space to maintain the saved content. In addition, the searching process can take significant time in view of the large amount of content to be searched. There is a need, therefore, to be able to automatically filter streaming content, for example, video streams and/or audio streams, to remove irrelevant and uninteresting video segments, storing only segments of interest to a particular user. For example, a user may wish to filter news broadcasts to identify and save only content regarding a particular topic, while filtering out irrelevant stories and information such as weather, sports, commercials, etc. Further, within an hour-long news broadcast, there may be only one or two stories that contain information of interest.

Accordingly, it would be desirable to have a method and system that enables automatic selective saving of desired content while discarding undesired content.

### SUMMARY OF THE INVENTION

The present invention is a method, system, and computer program product for selective filtering of video and audio content. In accordance with the present invention, the incoming content is broken into segments that are individually, on a segment-by-segment basis, analyzed using user-defined criteria, referred to as “cues”. Based on the quantity and weight of the cues in the segment, the segment is rated, i.e., given a score. If the score of a particular segment is above a predetermined threshold, the segment is stored for later use. If the segment is at or below the predetermined threshold, the segment is considered irrelevant or “uninteresting” relative to the user criteria, and the segment is discarded. In accordance with the present invention, incoming content is buffered and, in parallel, a cue analysis is performed to break the content into segments before performance of the rating process. In this manner, the streaming incoming content can be constantly monitored and analyzed and only the relevant/interesting segments are saved.

### BRIEF DESCRIPTION OF THE DRAWINGS

FIG. 1 illustrates the overall environment of the present invention;

FIG. 2 illustrates the filtering processor in more detail;

FIG. 3 illustrates the cue analysis processor in more detail;

FIG. 4 is a flowchart illustrating an example of steps performed in accordance with the present invention; and

FIG. 5 is a flowchart illustrating an example of steps performed during an initialization process in accordance with the present invention.

### DETAILED DESCRIPTION OF THE INVENTION

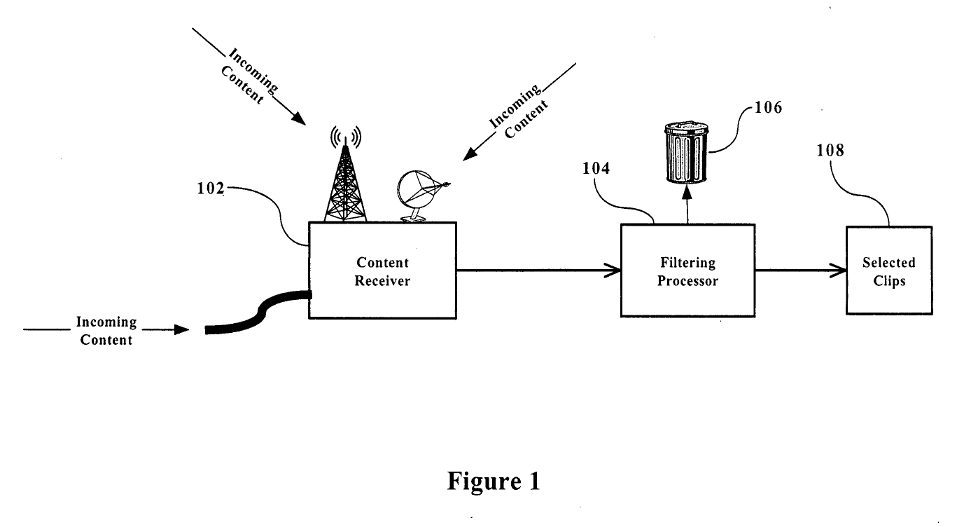

FIG. 1 illustrates the overall environment of the present invention. Referring to FIG. 1, a content receiver receives incoming content from multiple sources. For example, the content receiver can receive broadcast signals, satellite broadcast signals, and cable broadcast signals, i.e., the incoming content can be received from multiple sources. This content can include video content, audio content, textual content, closed-captioning data and the like, and can include any combination of such content types.

The incoming content is forwarded to a filtering processor 104. As described in more detail below, the filtering processor 104 breaks the incoming content into segments, preferably segments that are defined by “natural boundaries”, i.e., the beginning and end of a piece of video content relating to a particular subject, blank spots for commercials, a switch to a new segment that seems unrelated, etc. Although this segmenting can be done arbitrarily, it is preferable to keep subject matter together in terms of context so that one particular subject is covered by each segment. Any known method of identifying content boundaries to define the segments can be utilized, Filtering processor 104 is coupled to a “recycle bin”, if desired. As the filtering processor 104 filters out content that is irrelevant to the search desires of a particular user, it can be simply discarded, or can be placed in the recycling bin 106 for a predetermined save cycle, e.g., 24 hours. By using the recycling bin on a short-term basis, accidental discarding of content can be remedied as long as it is done within the save cycle of recycling bin 106.

Filtering processor 104 is output to a selected clips storage area 108. Selected clips storage area 108 is where content segments (clips) found to be of interest, based upon the user's criteria, are stored for later use.

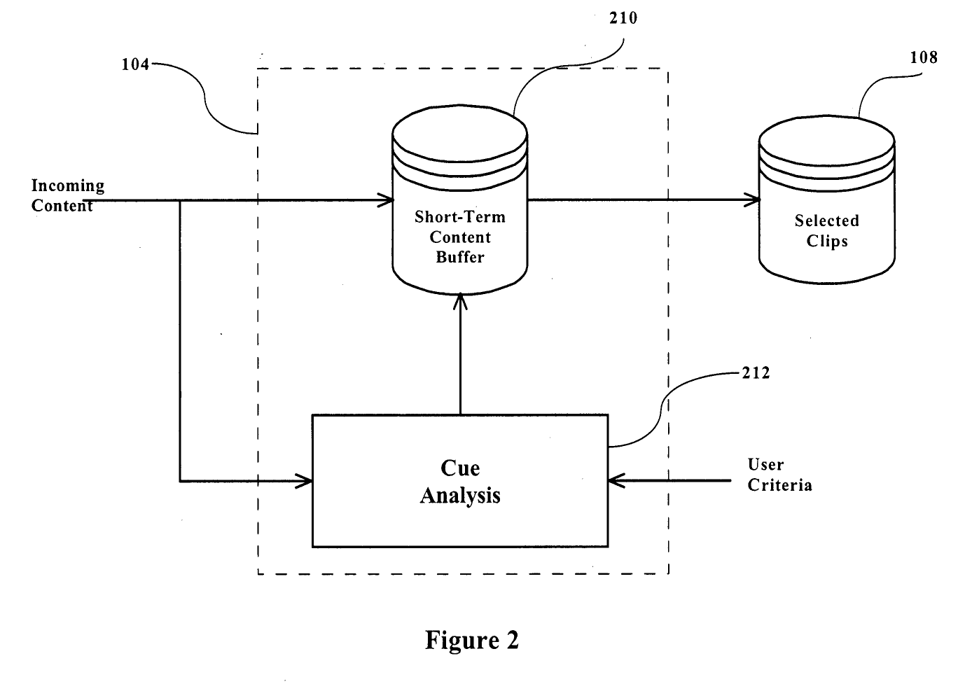

FIG. 2 illustrates filtering processor 104 in more detail. As can be seen from FIG. 2, the filtering processor 104 includes a short-term content buffer 210 and a cue analysis processor 212. As described in more detail below, the incoming video is stored both in short-term content buffer 210 and cue analysis processor 212. The term “cue analysis” as used herein refers the analysis of the content to identify pieces of information (the cues) in the content that identify the segment as being of interest, i.e., cue analysis describes the process of finding the cues. The term “evidence accrual” describes the process of adding up the cues found in a content segment and determining if the entire segment has sufficient evidence or cues to identify it as of interest.

The function of short-term content buffer 210 is to store the raw incoming content stream temporarily while cue analysis processor 212 performs the function of dividing the incoming content into natural segments, scoring the content of the segments based upon user criteria, and making a save/discard determination of each content segment based upon its score.

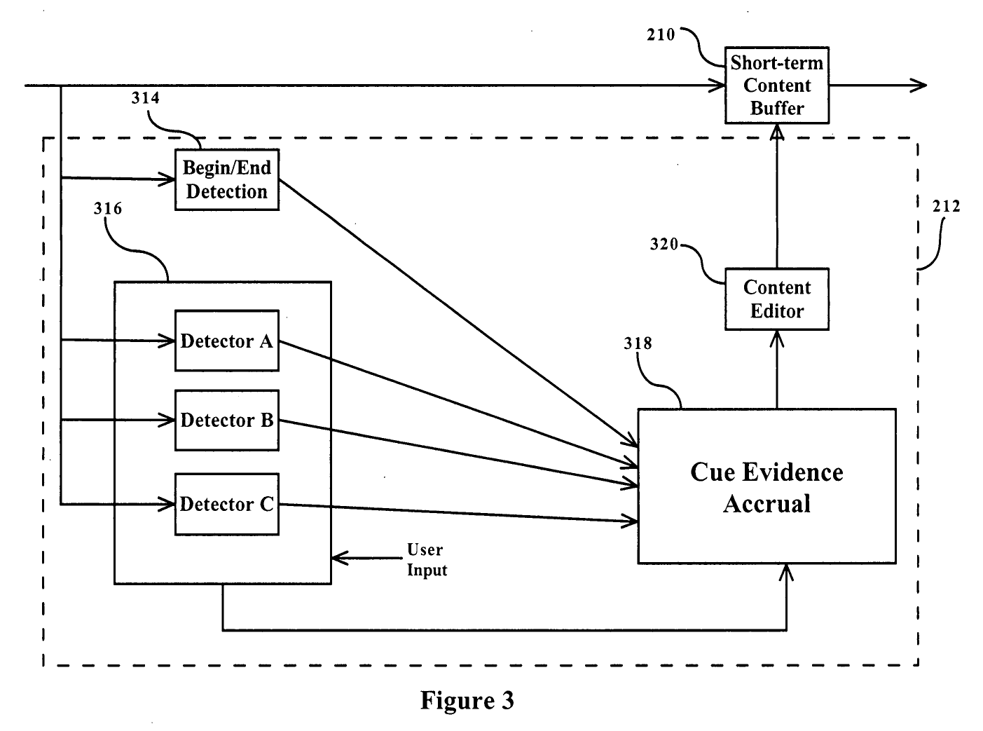

FIG. 3 illustrates the cue analysis processor 212 in more detail. Cue analysis processor 212 comprises a begin/end detection module 314, a cue detection module 316, a cue evidence accrual module 318, and a content editing module 320.

Begin/end detection module 314 breaks the content stream into segments. There are various manners in which the segment boundaries can be determined. For example, closed-captioning indicators, scene fades, audio silence, and music indicators and/or changes in music can all be used to determine segment boundaries. Any known method for identifying segment boundaries can be used, and numerous methods for identifying segment boundaries will be apparent to the skilled artisan.

Once the boundaries of a segment have been determined from the incoming content stream, the segment is then analyzed by cue detection module 316. As shown in FIG. 3, cue detection module 316 includes multiple detectors (detector A, detector B, detector C in this example) that are used to analyze the content segments for specific elements. Although three detectors are shown in the example of FIG. 3, it is understood that a fewer or greater number of detectors can be utilized and fall within the scope of the present invention. Typical detectors can include speech recognizers, speaker recognizers, face recognizers, text recognizers, and closed-captioned decoders. Any known detection process for analyzing audio and/or video and/or textual content can be utilized.

The cue detectors use selection criteria input by the user to determine which cues to look for. These selection criteria can include particular closed-caption or audio key words, pictures/images of faces of interest, and particular voice samples associated with particular individuals. When any of the cue detectors find a match to the selection criteria, the information about the match, including the keyword, the face match, etc. are temporarily stored in cue detection module 316 so that they may be used for scoring the segment when the segment analysis is completed. Alternatively, scoring can be done on an incremental basis, i.e., each time there is a “hit” with respect to the search criteria, a counter or other tallying means can be triggered to keep track of the number of hits.

Exclusionary criteria can also be used to identify “negative cues”, i.e., cues that when found can be used to reduce the score of a segment. For example, if a user want to look for content pertaining to a visit to London by former U.S. President Bill Clinton, but does not want to find content relating to the town of Clinton, N.J., the user might identify the terms “Clinton”, “London”, “visit”, etc. as high value terms, but might also give negative weighting to content that also includes the term “New Jersey”.

Video and audio content typically have timing codes that identify locations within the content. The timing codes are typically used, for example, to enable navigation to particular locations of the content in a well-known manner. In accordance with the present invention, the timing codes of the hits are also stored so that their locations can later be identified. Typical time codes are coded as hour, minute, second and frame number offsets from the beginning of the content or content segment.

Once a segment has been completely analyzed, all of the information, including the key words or other criteria that have been matched, the score of each match, and the time codes identifying the beginning and end of the segment and the location of any matches, are sent to the cue evidence accrual module 318. The cue evidence accrual module 318 processes all of the cues found from a particular segment, along with the criteria and weightings as input from the user. It then determines if a particular segment should be saved, based upon the predetermined score thresholds. In a typical implementation, a user will input a weight (positive or negative) for each of the criteria, plus a threshold value for saved segments. The cue evidence accrual module 318 is configured to tally up the weight values for all cues found in a segment and then compare the weighted values to the threshold values to determine if the segment matches the user's criteria. When a segment score is above the set threshold, the “begin” and “end” time codes for the segment are passed to the content editor module 320.

The content editor module 320 uses the beginning and ending time codes to designate the selected segment from the content buffer 210 for saving. These designated segments are stored in long-term memory (selected clips memory 108) for use by the user. Once all of the cue analysis tasks have been completed on the content currently stored in buffer 210, short-term content buffer 210 is flushed, i.e., the content stored therein is discarded or sent to recycling bin 106, and new content is input to the short-term content buffer 210 and to cue analysis processor 212.

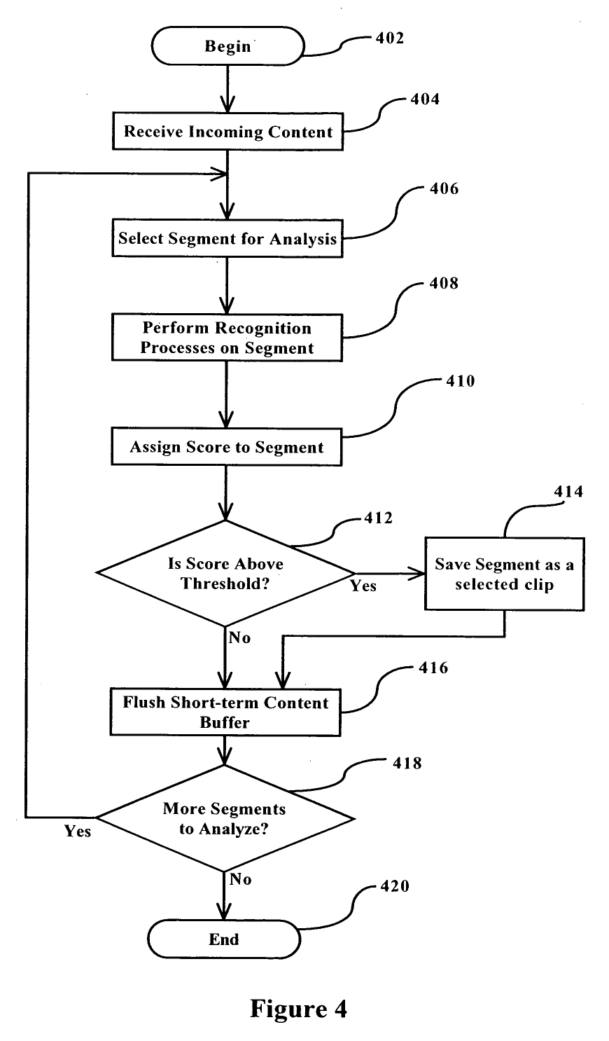

FIG. 4 is a flowchart illustrating an example of steps performed in accordance with the present invention. At step 402 the process begins, at step 404 the incoming content is received, and at step 406 a segment is selected for analysis. At step 408, the detection processes are performed on the segment, i.e., the segment is analyzed for the various detection factors as defined by the detectors present in cue detection module 316. At step 410, scores are assigned to the segment, and at step 412 a determination is made as to whether or not the score is above the predetermined threshold. If the score of the segment is above the predetermined threshold, the process proceeds to step 414, where the segment is saved as a selected clip, as described with respect to FIG. 3 above. If, however, at step 412, it is determined that the score is at or below the threshold, the process proceeds directly to step 416.

At step 416, the short-term content buffer is flushed, that is, all of the currently-stored content is discarded. At step 418, it is determined whether or not there are more segments to analyze. If there are more segments to analyze, the process proceeds back to step 406 and the next segment is selected for analysis. If there are no additional segments to analyze, the process ends at step 420.

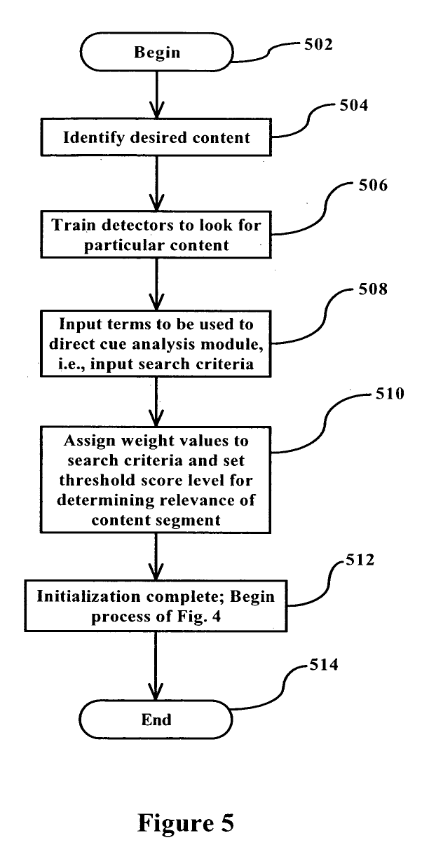

FIG. 5 is a flowchart illustrating an example of steps performed during an initialization process in accordance with the present invention. At step 502, the initialization process begins, and at step 504, the user of the system identifies the content that they wish to find among the various content sources being monitored. This typically will involve the user simply giving thought to what they are looking for (e.g., content regarding a particular person, subject, place, event, etc.) to assist them in determining the search criteria to be used during the detection process.

At step 506, the content detectors (e.g., video detector, audio detector, text detector, etc.) are trained based on the content identified in step 504. For example, if the user wishes to locate content regarding a particular individual, then at step 506, a face recognition cue detector could be trained using pictures of the individual, and a speaker recognition cue detector could be trained with voice clips of the particular person speaking.

At step 508, terms are input that identify to the system of the present invention what to search for. For example, key words that would be found in text or speech files of interest can be input via, for example, a keyboard or other input device. Similarly, inputting of a particular name (e.g., the name of the individual of interest) could be utilized by the system to direct it to search for video and/or audio files that include images of and/or voice clips of the particular individual. Further, search terms that the user may wish to exclude or have negative weighting values can also be input at this step.

At step 510, the various training and/or search criteria input in steps 506 and 508 are assigned weight values as described above, so that each criteria will be evaluated based on the positive or negative weight with which it is associated. The user also decides the threshold level to be used to identify relevant or irrelevant content (e.g., the user identifies the score value at which content is considered relevant) and inputs the threshold value to the system. This completes the initialization process, and the system is then ready to begin analyzing content.

The present invention allows the user to specify criteria for determining the interest level of content segments. It allows automatic searching, on-the-fly, on an ongoing basis. It can be performed automatically with little or no user input beyond the initial designation of the parameters used for analyzing the scores of the segments and the threshold values above which the segments should be saved.

Following is a simplified example illustrating the operation of the present invention. Assume that a user is interested in stories about U.S. President George Bush visiting Japan. The user trains the face recognition cue detector with pictures of George Bush and the speaker recognition system with audio segments of President Bush speaking. The user then inputs to the cue analysis module 212 terms, e.g., “George Bush”, “President Bush”, and “Japan”. These terms would be given high weightings. Other useful terms, but with a lower weighting, might include “president”, “visit”, and “trip”. A user may also enter terms and give them negative weights, such as “bush” (with a lowercase “b”), “tree”, “shrub”, “foliage”, and “leaves”, to lower the possibility of false matches from stories about Japanese bushes.

Content is then received and segmented as described above. Each segment is searched, using the various detectors, to identify content that contains pictures and/or speech of George Bush, and the audio segments and text segments (e.g., closed captioning and/or graphics appearing on a video segment) are searched for the keywords input during step 508 of FIG. 5. If the content includes pictures of George Bush, each “hit” involving an image of George Bush will be given, for example, a high weight value. Likewise, audio text containing speech segments of George Bush may have a high weight value as well. If the term “Japan” is used in the segment, that too will be weighted highly, and the terms “trip” and visit” appearing in the content will also be recognized and given a lower, positive value. “Negative terms” such as bush, shrub, etc. will also be identified and given a negative weight value. If desired, occurrences of multiple “hits” in the same segment (e.g., “George Bush” and “Japan” or a voice segment of George Bush combined with the terms “Japan” and “visit” in some form in the segment) can be given an even higher rating since their occurrence together in the same segment is an indication of a potentially higher degree of relevance.

Once the segment has been analyzed, the score of the segment, based on the weight values, is calculated by adding up the individual scores and then comparing the total with the threshold level. If the score is above the threshold, the segment will be identified and saved. If the score is at or below the threshold, it will be discarded.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

We claim:

1. A system for selective filtering of content streams, comprising:
a content receiver;
a filtering processor coupled to receive content received by said content receiver; and
a selected-content storage device coupled to said filtering processor,
wherein said filtering processor is configured to automatically discard undesired content and automatically store desired content in said selected-content storage device.

2. The system of claim 1, wherein said filtering processor comprises:
a cue analysis processor coupled to said content receiver; and
a short-term content buffer coupled to said content receiver and said cue analysis processor;
wherein said cue analysis processor analyzes content received by said content receiver to identify cues in the content that identify the content as desired content.

3. The system of claim 2, wherein said cue analysis processor comprises:
a begin/end detection module breaking said content into two or more segments; and
a cue detection module analyzing each of said two or more segments to identify desired content elements within each segment and a weighted value for each desired content element.

4. The system of claim 3, wherein said cue analysis processor further comprises:
a cue evidence accrual module coupled to said cue detection module, processing the identified desired content elements within each segment to determine if said segment is a desired segment based on the weighted value of all of the desired content elements within said segment.

5. The system of claim 4, wherein said cue detection module comprises a plurality of detectors configured to analyze the content, with each detector performing its content analysis for specific content elements different than those performed by the other detector(s).

6. The system of claim 5, wherein said plurality of detectors include a face recognition detector and a voice recognition detector.

7. The system of claim 5, wherein said cue analysis processor further comprises a content editor coupled to said cue evidence accrual module and to said short-term content buffer, said content editor configured to receive begin and end codes for content that has been determined by said cue evidence accrual module to be desired content and, using said begin and end codes, designating said desired content for saving in said selected content storage device.

8. The system of claim 7, wherein said content buffer is configured to be flushed once all of the content stored therein has been analyzed by said filtering processor and all desired content from among the content stored in said filtering processor has been saved in said selected content storage device.

9. A method for selective filtering of content streams, comprising:
receiving content;
analyzing said content to identify desired and undesired content segments; and
automatically discarding undesired content segments and automatically storing desired content segments in a selected-content storage device.

10. The method of claim 9, wherein said analysis comprises:
analyzing said content to identify cues in the content that identify the content as desired content.

11. The method of claim 10, further comprising:
breaking said content into two or more segments; and
analyzing each of said two or more segments to identify desired content elements within each segment and a weighted value for each desired content element.

12. The method of claim 11, further comprising:
processing the identified desired content elements within each segment to determine if said segment is a desired segment based on the weighted value of all of the desired content elements within each segment.

13. The method of claim 12, further comprising:
identifying begin and end codes for content that has been determined to be desired content and, using said begin and end codes, designating said desired content for saving in said selected content storage device.

14. A computer program product for selective filtering of content streams, the computer program product comprising a computer-readable storage medium having computer-readable program code embodied in the medium, the computer-readable program code comprising:
computer-readable program code that receives content;
computer-readable program code that analyzes said content to identify desired and undesired content segments; and
computer-readable program code that automatically discards undesired content segments and automatically storing desired content segments in a selected-content storage device.

15. The computer program product of claim 14, wherein said computer-readable program code that analyzes content analyzes said content to identify cues in the content that identify the content as desired content.

16. The computer program product of claim 15, further comprising:
computer-readable program code that breaks said content into two or more segments; and
computer-readable program code that analyzes each of said two or more segments to identify desired content elements within each segment and a weighted value for each desired content element.

17. The computer program product of claim 16, further comprising:
computer-readable program code that processes the identified desired content elements within each segment to determine if said segment is a desired segment based on the weighted value of all of the desired content elements within each segment.

18. The computer program product of claim 17, further comprising:
computer-readable program code that identifies begin and end codes for content that has been determined to be desired content and, using said begin and end codes, designating said desired content for saving in said selected content storage device.
